(19) United States
(12) Patent Application Publication
(10) Pub. No.: US 2011/0225056 A1
(43) Pub. Date: Sep. 15, 2011

(54) CHECKOUT APPARATUS AND MODE SWITCHING METHOD

(75) Inventor: Masahiro Akiyama, Shizuoka (JP)

(73) Assignee: TOSHIBA TEC KABUSHIKI KAISHA, Tokyo (JP)

(21) Appl. No.: 13/043,976

(22) Filed: Mar. 9, 2011

(30) Foreign Application Priority Data
Mar. 12, 2010 (JP) 2010-056435

(51) Int. Cl. A47F 9/04; G06Q 30/00

(52) U.S. Cl. 705/16

(57) ABSTRACT

According to one embodiment, a checkout apparatus includes an apparatus body, a monitor, a rotation mechanism, a lock mechanism, a notification unit, and a control unit. The apparatus body can switch a mode for checkout processing between a cashier mode in which a cashier operates the apparatus and a self-service mode in which a customer operates the apparatus. The monitor is provided on the apparatus body and displays a status of the checkout processing. The rotation mechanism rotates the apparatus body. The lock mechanism locks the rotation of the rotation mechanism at least at two positions. The notification unit causes the monitor to display guidance showing a procedure for mode switching, including locking and unlocking by the lock mechanism. The control unit switches checkout processing modes in response to that the rotation of the rotation mechanism is stopped at one of the positions with the locking by the lock mechanism.

### CROSS-REFERENCE TO RELATED APPLICATIONS

This application is based upon and claims the benefit of priority from Japanese Patent Application No. 2010-056435, filed on Mar. 12, 2010, the entire contents of which are incorporated herein by reference.

### FIELD

Embodiments described herein relate generally to a checkout apparatus capable of input of information about an article purchased by a customer and settlement of a commercial transaction with the customer.

### BACKGROUND

A checkout apparatus is capable of input of information about an article purchased by a customer and settlement of a commercial transaction with the customer. For example, when a barcode attached to an article is read by a scanner, the checkout apparatus input article information including article name and price based on barcode data.

Such checkout apparatus is usually operated by a cashier who is in charge of this operation in a store. Recently, a self-service checkout apparatus improved to enable a customer to operate is also put into practice use.

A checkout apparatus capable of switching between cashier operation and self-service operation is developed. A mechanical system is necessary for switching between cashier operation and self-service operation. There is demand for reduction in time required for the operation of this mechanism.

### BRIEF DESCRIPTION OF THE DRAWINGS

FIG. 1 shows the appearance of an embodiment of a checkout apparatus.

FIG. 2 is a side view showing a turntable in the apparatus.

FIG. 3 shows an arrangement where the apparatus is directed toward a cashier side.

FIG. 4 shows an arrangement where the apparatus is directed toward a customer side.

FIG. 5 is a block diagram showing a main configuration of the apparatus.

FIG. 6 is a flowchart showing processing procedures in a CPU according to a mode switching program installed in the apparatus.

FIG. 7 shows an exemplary icon displayed on a display of the apparatus.

FIG. 8 shows transition of guidance displayed on the display of the apparatus.

### DETAILED DESCRIPTION

In general, according to one embodiment, a checkout apparatus includes an apparatus body, a monitor, a rotation mechanism, a lock mechanism, a notification unit, and a control unit. The apparatus body can switch a mode for checkout processing between a cashier mode in which a cashier operates the apparatus and a self-service mode in which a customer operates the apparatus. The monitor is provided on the apparatus body and displays a status of the checkout processing. The rotation mechanism rotates the apparatus body. The lock mechanism locks the rotation of the rotation mechanism at least at two positions. The notification unit causes the monitor to display guidance showing a procedure for mode switching, including locking and unlocking by the lock mechanism. The control unit switches checkout processing modes in response to that the rotation of the rotation mechanism is stopped at one of the positions with the locking by the lock mechanism.

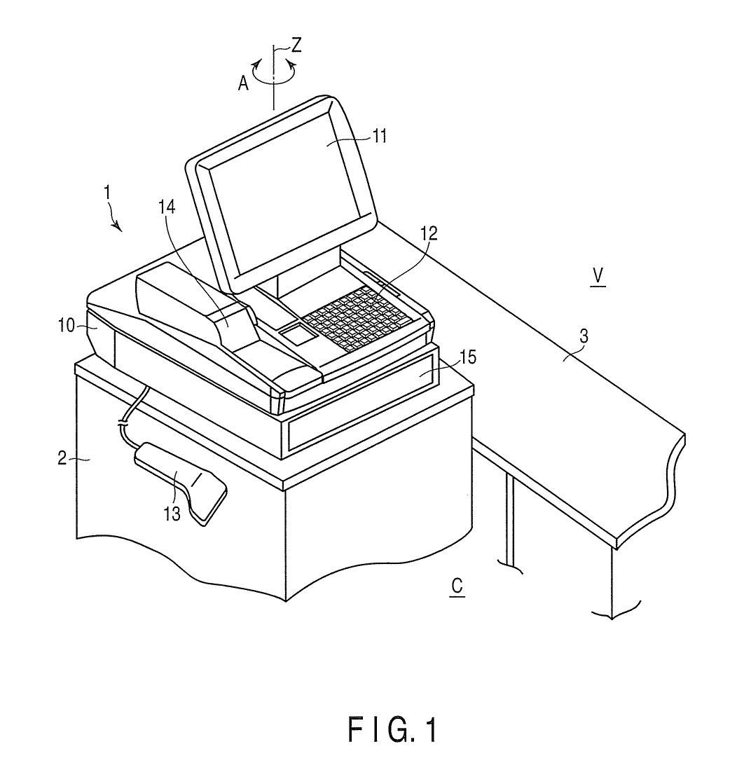

FIG. 1 shows the appearance of the checkout apparatus. This checkout apparatus (hereinafter, the present apparatus) 1 can switch between a cashier mode in which a cashier operates the apparatus and a self-service mode in which a customer operates the apparatus, as checkout processing modes.

The checkout processing includes processing to acquire article information such as article name and unit price according to an input of an article code that identifies an article, processing to register sales data to a memory based on the article information and calculate a total amount in a commercial transaction, processing to settle the commercial transaction based on the total amount and price data when the price data is inputted, and processing to issue a receipt on which a content of the settled commercial transaction is recorded.

An apparatus body 10 of the present apparatus 1 is placed on a first table 2 arranged, for example, at a checkout corner in a store. A second table 3 for a customer to put a shopping basket on is provided parallel to the first table 2. A side of the second table 3 where the checkout apparatus 1 is arranged is referred to as a side of a cashier C. An opposite side is referred to as a side of a customer V. The present apparatus 1 has a display 11 for monitoring, a keyboard 12, a barcode scanner 13, a receipt printer 14 and a drawer 15, in the apparatus body 10.

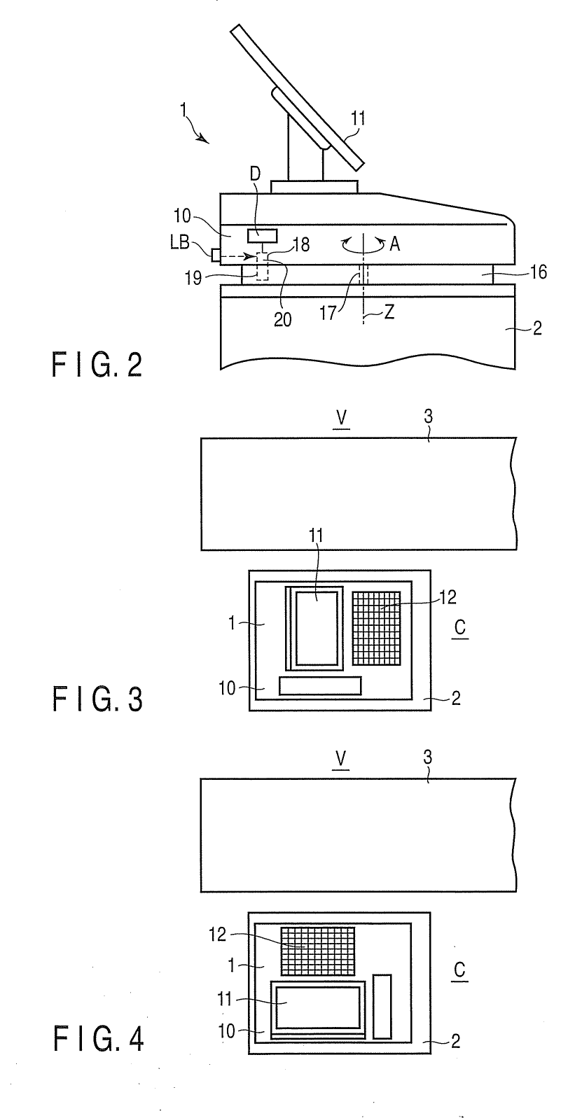

As shown in FIG. 2, the apparatus body 10 is placed on the first table 2 via a turntable 16. The turntable 16 rotates the apparatus body 10 in a direction of arrow A about an axis Z. The turntable 16 is, for example, a disc-shaped and has a rotation axis 17 at its center position. The turntable 16 has its rotation locked by a lock mechanism (stopper) 18.

The lock mechanism 18 includes a bar-like lock member 20, a lock button LB, and a driver D for the lock member 20. The driver D moves the lock member 20 forward and backward in its longitudinal direction. The driver D stops when the movement of the lock member 20 is regulated.

When the lock member 20 moves forward, the lock member 20 can be inserted, from its distal end, into one of plural holes 19 opened on a top surface of the turntable 16. As the lock member 20 is inserted in one of the holes 19, the turntable 16 becomes locked. When the lock member 20 moves backward, the lock member 20 exits the hole 19. As the lock member 20 exits the hole 19, the turntable 16 becomes unlocked.

The holes 19 are opened at two positions at a space of 90 degrees near a peripheral edge part on the top surface of the turntable 16. A first hole 19a is a hole for the cashier mode. A second hole 19b is a hole for the self-service mode. The first hole 19a and the second hole 19b have different depths. Therefore, a controller of the apparatus 1 can determine in which of the first hole 19a and the second hole 19b the lock member 20 is inserted, based on the time taken from the driver D starts to move the lock member 20 forward, until the distal end of the lock member 20 is abutted against a bottom surface of the hole 19 and then the driver D stops.

For example, when the lock member 20 is inserted in the first hole 19a and the turntable 16 is locked, the front of the apparatus body 10 (a forward side from the keyboard 12) is arranged to the side of the cashier C, as shown in FIG. 3. When the lock member 20 is inserted in the second hole 19b and the turntable 16 is locked, the front of the apparatus body 10 is arranged to the side of the customer V, as shown in FIG. 4.

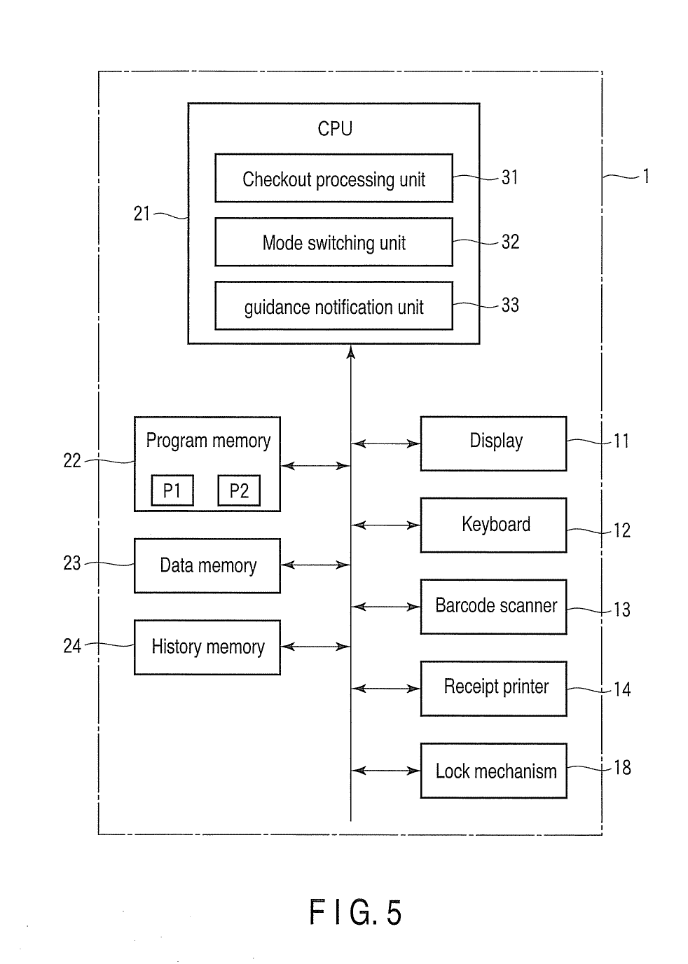

FIG. 5 is a block diagram showing a main configuration of the checkout apparatus 1. The present apparatus 1 is equipped with a CPU 21 as the controller. In the present apparatus 1, the display 11, the keyboard 12, the barcode scanner 13, the receipt printer 14, the lock mechanism 18, a program memory 22, a data memory 23 and a history memory 24 are connected to the CPU 21.

The program memory 22 stores a checkout processing program P1 and a mode switching program P2.

The data memory 23 stores an ID number that is a manager identification number. The ID number is a unique number that is preset for a clerk authorized to switch modes. For example, each clerk holds a name tag on which a barcode indicating the clerk's ID number is printed. The clerk inputs the clerk's own ID number to the present apparatus 1 by having the barcode read by the scanner 13.

The history memory 24 stores history information of the switching of the checkout processing modes. The history information includes the date and time when modes are switched and the ID number of an operator who operates the mode switching.

The CPU 21 has functions of a checkout processing unit 31, a mode switching unit 32, and a guidance notification unit 33. The checkout processing unit 31 executes the above checkout processing according to the checkout processing program P1. The checkout processing includes checkout processing in the cashier mode and checkout processing in the self-service mode.

The mode switching unit 32 switches the mode of the checkout processing between the cashier mode and the self-service mode according to the mode switching program P2. The guidance notification unit 33 displays on the display 11 guidance showing procedures for the mode switching operation for the checkout processing, according to the mode switching program P2.

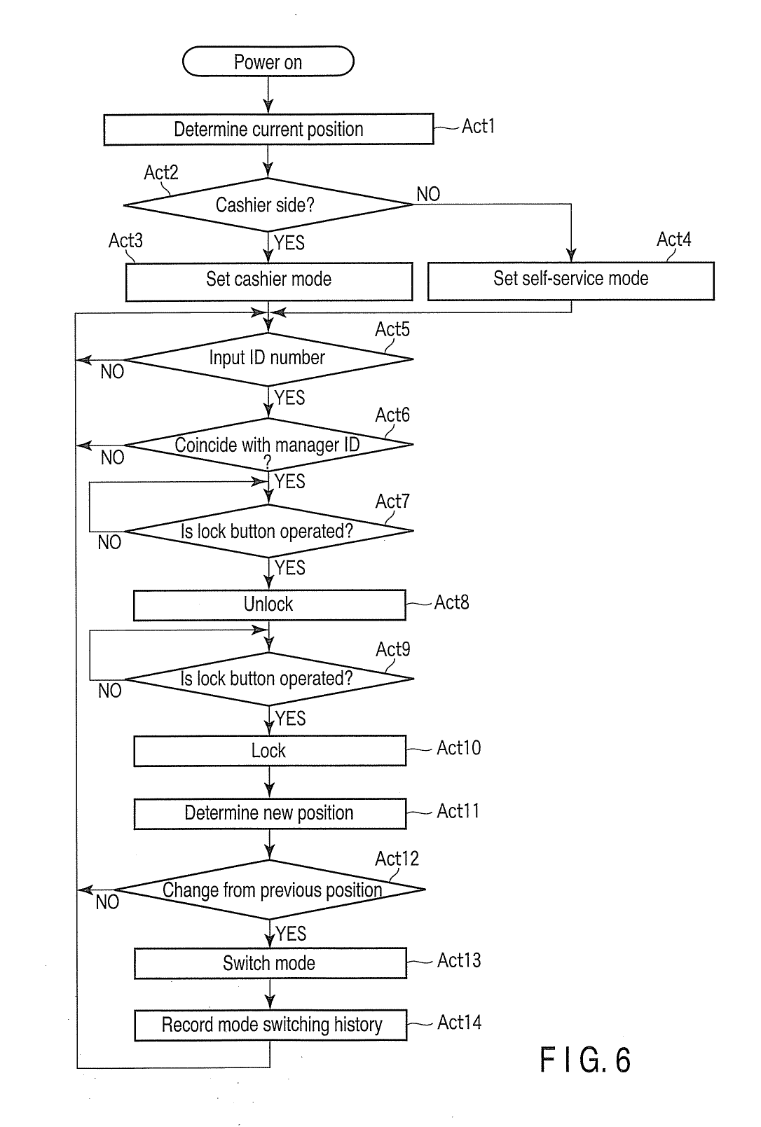

When the mode switching program P2 is started as power is turned on in the checkout apparatus 1, the CPU 21 executes a process routine of procedures shown in the flowchart of FIG. 6.

First, the CPU 21 determines the current position of the apparatus body 10 (Act 1). For example, the CPU 21 outputs a signal commanding the lock mechanism 18 to unlocking. Then, the driver D is driven and the lock member 20 moves backward and exits one of the holes 19. As the lock member 20 finishes moving backward and the driver D stops, the CPU 21 outputs a signal commanding the lock mechanism 18 to lock. Then, the driver D is driven again and the lock member 20 moves forward and is inserted into the same hole 19. Then, when the distal end of the lock member 20 is abutted against the bottom surface of the hole 19, the driver D stops.

The CPU 21 measures the time taken until the driver D stops after the lock command signal is outputted. The CPU 21 then determines whether the hole 19 is the first hole 19a or the second hole 19b, based on this time. When the hole 19 is the first hole 19a, the CPU 21 recognizes the current position of the apparatus body 10 as the side of the cashier C (Act 2). When the hole 19 is the second hole 19b, the CPU 21 recognizes the current position of the apparatus body 10 as the side of the customer V (Act 2). The CPU 21 stores information identifying the recognized position, in the data memory 23.

When the current position of the apparatus body 10 is recognized as the side of the cashier C, the CPU 21 sets the cashier mode as the mode for the checkout processing (Act 3). When the current position of the apparatus body 10 is recognized as the side of the customer V, the CPU 21 sets the self-service mode as the mode for the checkout processing (Act 4).

By the way, when the cashier mode is set, a screen displayed on the display 11 is controlled so that the checkout processing is executed through the operation of the present apparatus 1 by the cashier C. When the self-service mode is set, the screen displayed on the display 11 is controlled so that the checkout processing is executed through the operation of the present apparatus 1 by the customer V. These screen controls are realized by the checkout processing unit 31.

The CPU 21 waits for an ID number to be inputted externally (Act 5). For example, when an ID number in the form of barcode is read by the barcode scanner 13, the CPU 21 collates the ID number with the manager ID numbers stored in the data memory 23 and determines whether there is a manager ID number that coincides with the inputted ID number (Act 6). When there is no manager ID number that coincides with the inputted ID number, the CPU 21 waits for the next ID number to be inputted (Act 5).

When a manager ID number that coincides with the inputted ID number is stored in the data memory 23, the CPU 21 waits for the lock button LB to be operated (Act 7). When a signal indicating that the lock button LB is operated is inputted from the lock mechanism 18, the CPU 21 outputs a signal commanding the lock mechanism 18 to unlock (Act 8).

After that, the CPU 21 waits again for the lock button LB to be operated (Act 9). When a signal indicating that the lock button LB is operated is inputted from the lock mechanism 18, the CPU 21 outputs a signal commanding the lock mechanism 18 to lock (Act 10).

Then, the driver D is driven and the lock member 20 moves forward. At this time, if one of the holes 19 faces a site facing the lock member 20, the lock member 20 is inserted into that hole 19 and the turntable 16 becomes locked.

When the turntable 16 is locked, the CPU 21 determines a new position of the apparatus body 10 (Act 11). The determination method is as described above. After the new position is determined, the CPU 21 determines whether or not the position is changed from the position specified by the identification information stored in the data memory 23 (Act 12). When the position is the same as the previous position, the CPU 21 waits for the next ID number to be inputted (Act 5).

When the position is different, the CPU 21 switches the mode for the checkout processing (Act 13). That is, when the mode immediately before is the cashier mode, the CPU 21 switches to the self-service mode. When the mode immediately before is the self-service mode, the CPU 21 switches to the cashier mode.

The CPU 21 records data identifying the new mode, the date and time when the mode is switched and the inputted ID number, in the history memory 24 (Act 14). After that, the CPU 21 waits for the next ID number to be inputted (Act 5). The foregoing functions are realized by the mode switching unit 32.

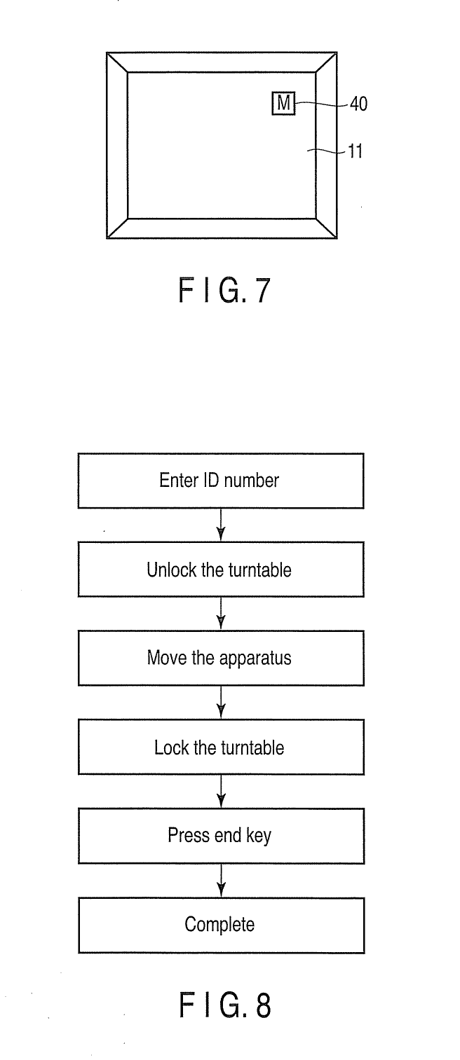

By the way, while waiting for the input of an ID number, the CPU 21 displays an icon 40 as a mark to prompt the display of guidance on the display 11, as shown in FIG. 7. Then, when the icon 40 is selected, for example, by clicking on a mouse, not shown, the CPU 21 displays guidance on the display 11 in the order shown in FIG. 8.

First, the CPU 21 displays guidance prompting the input of an ID number, for example, “Enter ID number”, on the display 11.

When an ID number that coincides with the manager ID number is inputted, the CPU 21 displays guidance prompting the unlocking of the turntable 16, for example, “Unlock the turntable 16”, on the display 11.

When the lock button LB is operated, the CPU 21 displays guidance prompting the rotation of the apparatus body 10, for example, “Move the apparatus”, on the display 11. Subsequently, for example, when a specific key on the keyboard 12 is operated, the CPU 21 displays guidance prompting the locking of the apparatus body 10, “Lock the turntable”, on the display 11.

When the lock button LB is operated again, the CPU 21 displays guidance prompting an end operation, for example, “Press End key, on the display 11.

When the End key on the keyboard 12 is operated, the CPU 21 displays a message notifying of the completion of the mode switching operation, for example, “Complete”, on the display 11. The foregoing functions are realized by the guidance notification unit 33.

It is now assumed, for example, that the apparatus body 10 faces the side of the cashier C as shown in FIG. 3. When power is turned on in the checkout apparatus 1 in this state, the cashier mode is set as the mode for the checkout processing in the checkout apparatus 1.

In the case of switching the mode for the checkout processing from the cashier mode to the self-service mode, the operator clicks the icon 40 on the display 11. Then, the guidance “Enter ID number” is displayed on the display 11 and therefore the operator operates the scanner 13 to input the operator's own ID number.

When the inputted ID number coincides with one of the manager ID numbers stored in the data memory 23, the guidance “Unlock the turntable 16” is displayed on the display 11. After confirming this guidance, the operator operates the lock button LB.

When the lock button LB is operated, the lock mechanism 18 unlocks and the guidance “Move the apparatus” is displayed on the display 11. Thus, the operator pushes the lateral side of the apparatus body 10 with his or her hand and rotates the apparatus body 10 by 90 degrees so that the front of the apparatus body 10 faces the side of the customer V, from the position where the front of the apparatus body 10 faces the side of the cashier C.

After rotating the apparatus body 10 by 90 degrees, the operator inputs a specific key on the keyboard 12. Then, the guidance “Lock the turntable” is displayed on the display 11. Therefore, the operator operates the lock button LB again.

As the lock button LB is operated, the turntable 16 is locked by the lock mechanism 18 and the guidance “Press End key” is displayed on the display 11. Thus, the operator operates the End key. Then, the guidance “Complete” is displayed on the display 11.

In the checkout apparatus 1, the mode for the checkout processing is switched from the cashier mode to the self-service mode. The history information including the current date and time and the operator's ID number is recorded in the history memory 24.

Similar operations are carried out in the case of switching the mode for the checkout processing in the checkout apparatus 1 from the self-service mode to the cashier mode. That is, the operator first inputs the ID number according to the guidance. Subsequently, the operator operates the lock button LB and rotates the apparatus body 10 by 90 degrees in the opposite direction. Finally, the operator operates the lock button LB again and then presses the End key.

As the operator executes the operations according to the above procedures, the mode for the checkout processing in the checkout apparatus 1 is switched from the self-service mode to the cashier mode. The history information including the current date and time and the operator's ID number is recorded in the history memory 24.

According to the one embodiment, the operator can switch the mode for the checkout processing between the cashier mode and the self-service mode simply by carrying out operations according to the guidance on the display 11. Therefore, the procedures for the switching operation are easy to understand and the mode can be easily switched. Thus, the time required for the switching can be reduced.

Moreover, since the checkout apparatus 1 confirms the ID number and then permits the mode switching, an unauthorized person who has no relations with the present apparatus 1 is prevented from switching to each mode.

Other embodiments will be described hereinafter.

In the one embodiment, the guidance displayed on the display 11 is texts. However, the guidance is not limited to texts. For example, more detailed guidance may be notified of by displaying a picture, photograph or dynamic image showing an operation content. The guidance may also be notified of via an audio output together with the display.

In the one embodiment, the angle of rotation between the cashier side C and the customer side V is 90 degrees. However, this angle is not limited to 90 degrees. Any arbitrary angle can be dealt with as the lock position by the lock mechanism 18 can be aligned with the angle. The positions at which the turntable 16 is locked are not limited to the two positions. The turntable 16 may also be locked at three or more positions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout apparatus comprising:
an apparatus body which can switch a mode for checkout processing between a cashier mode in which a cashier operates the apparatus and a self-service mode in which a customer operates the apparatus;
a monitor which is provided on the apparatus body and displays a status of the checkout processing;
a rotation mechanism which rotates the apparatus body;
a lock mechanism which locks the rotation of the rotation mechanism at least at two positions;
a notification unit which causes the monitor to display guidance showing a procedure for mode switching, including locking and unlocking by the lock mechanism; and
a control unit which switches the mode for checkout processing in response to that the rotation of the rotation mechanism is stopped at one of the positions with the locking by the lock mechanism.

2. The apparatus of claim 1, wherein the lock mechanism locks the rotation of the rotation mechanism at a first position and a second position which is different from the first position, and
the control unit switches from the self-service mode to the cashier mode when the rotation of the rotation mechanism is locked at the first position, and switches from the cashier mode to the self-service mode when the rotation is locked at the second position.

3. The apparatus of claim 2, wherein the control unit determines at the time of startup whether the lock mechanism locks the rotation of the rotation mechanism at the first position or the second position, and selects the cashier mode when the rotation is locked at the first position, and selects the self-service mode when the rotation is locked at the second position.

4. The apparatus of claim 1, further comprising a storage unit which stores a manager identification number,
wherein the control unit allows the lock mechanism to unlock when an externally inputted identification number coincides with the manager identification number stored in the storage unit.

5. The apparatus of claim 4, wherein the notification unit displays guidance prompting input of the identification number, and displays guidance for unlocking when the lock mechanism is allowed to unlock, and displays guidance prompting the rotation and locking of the apparatus body when the locking mechanism is unlocked.

6. The apparatus of claim 4, wherein after switching the mode, the control unit records history of switching of the mode including the externally inputted identification number.

7. The apparatus of claim 1, wherein the notification unit causes the monitor to display an icon prompting the display of the guidance, and starts the guidance when this icon is operated.

8. A mode switching method for a checkout apparatus which can switch a mode for checkout processing between a cashier mode in which a cashier operates the apparatus and a self-service mode in which a customer operates the apparatus, the method comprising:
displaying guidance prompting unlocking by a lock mechanism which locks rotation of a rotation mechanism which rotates a body of the checkout apparatus, on a monitor provided on the body;
displaying, on the monitor, guidance prompting rotation of the rotation mechanism and locking by the lock mechanism when the rotation mechanism is unlocked; and
switching the mode for the checkout processing when the rotation mechanism is locked.

9. The method of claim 8, further comprising:
displaying guidance prompting input of an identification number, on the monitor; and
displaying guidance prompting unlocking by the lock mechanism when the identification number that is externally inputted coincides with a manager identification number stored in a storage unit and the lock mechanism is allowed to unlock.

10. A non-transitory computer-readable medium storing a program which causes a computer of a checkout processing apparatus capable of switching a mode for checkout processing between a cashier mode in which a cashier operates the apparatus and a self-service mode in which a customer operates the apparatus, to carry out the following process routine:
displaying guidance prompting unlocking by a lock mechanism which locks rotation of a rotation mechanism which rotates a body of the checkout apparatus, on a monitor provided on the body;
displaying, on the monitor, guidance prompting rotation of the rotation mechanism and locking by the lock mechanism when the rotation mechanism is unlocked; and
switching the mode for the checkout processing when the rotation mechanism is locked.
